(19) United States
(12) Patent Application Publication
(10) Pub. No.: US 2025/0341637 A1
(43) Pub. Date: Nov. 6, 2025

(54) ULTRASONIC SENSOR

(71) Applicant: DENSO CORPORATION, Kariya-city (JP)

(72) Inventors: Kenji FUKABORI, Kariya-city (JP); Kota TOYAMA, Kariya-city (JP)

(21) Appl. No.: 19/264,361

(22) Filed: Jul. 9, 2025

Related U.S. Application Data
(63) Continuation of application No. PCT/JP2023/046409, filed on Dec. 25, 2023.

(30) Foreign Application Priority Data
Jan. 11, 2023 (JP) 2023-002633

(51) Int. Cl. G01S 15/931; G01S 7/521

(52) U.S. Cl. CPC G01S 15/931; G01S 7/521; G01S 2015/938

(57) ABSTRACT

An ultrasonic sensor configured to be attached to a plate-shaped vehicle body component is provided with a tubular housing component that is inserted into a through-hole formed in the vehicle body component, and a vibration-proof rubber that, as a result of being attached to the housing component, is interposed between the housing component and the vehicle body component in an attached state, in which the housing component is attached to the vehicle body component. The vibration-proof rubber has three or more insertion sections that, in the attached state, as a result of being inserted through the through-hole, are held between an inner edge of the through-hole and the housing component in a radial direction that intersects a center axis line of the housing component, and the three or more insertion sections are arranged so as to surround the center axis line.

### CROSS-REFERENCE TO RELATED APPLICATION

The present application is a continuation application of International Application No. PCT/JP2023/046409, filed on Dec. 25, 2023, which claims priority to Japanese Patent Application No. 2023-002633, filed on Jan. 11, 2023. The contents of these applications are incorporated herein by reference in their entirety.

### BACKGROUND

### Technical Field

The present disclosure relates to an ultrasonic sensor that is attached to a plate-shaped vehicle body component (such as a bumper).

### Background Art

The conventional ultrasonic sensor is attached to the bumper of a vehicle, and used as a back sonar or a corner sonar. Specifically, a sensor main body, which is integrated with a bezel and vibration-suppressing member, is inserted into a hole in a bumper from the outside of the bumper. The bezel is a tubular member having a hollow section, and is made of a synthetic resin or the like. Then, a retainer is attached to the rear side of the bumper. The retainer is a member for fixing the sensor main body and the bezel to the bumper, and is made of a synthetic resin or the like.

### SUMMARY

In the present disclosure, provided is an ultrasonic sensor as the following.

The ultrasonic sensor configured to be attached to a plate-shaped vehicle body component includes: a tubular housing component that is inserted into a through-hole formed in the vehicle body component; and a vibration-proof rubber that, as a result of being attached to the housing component, is interposed between the housing component and the vehicle body component in an attached state, in which the housing component is attached to the vehicle body component; in which the vibration-proof rubber has three or more insertion sections that, in the attached state, as a result of being inserted through the through-hole, are held between an inner edge of the through-hole and the housing component in a radial direction that intersects a center axis line of the housing component, and the three or more insertion sections are arranged so as to surround the center axis line.

### BRIEF DESCRIPTION OF THE DRAWINGS

FIG. 1 is a perspective view showing the appearance of a vehicle equipped with ultrasonic sensors according to an embodiment of the present disclosure.

FIG. 2 is a back view showing enlarged a peripheral portion of a mounting hole, which is a through-hole formed in a bumper shown in FIG. 1.

FIG. 3 is a bottom view showing enlarged a schematic configuration of an ultrasonic sensor in the vehicle-mounted state shown in FIG. 1.

FIG. 4 is a bottom view showing a schematic configuration of the sensor main body shown in FIG. 3.

FIG. 5 is a bottom view showing the sensor main body shown in FIG. 4 exploded into a sensor case and a bezel.

FIG. 6 is a bottom view showing a state where a vibration-proof rubber has been removed from the bezel shown in FIG. 5.

FIG. 7 is a cross-sectional view showing a state where the bezel and the vibration-proof rubber shown in FIG. 5 have been attached to a bumper.

FIG. 8 is a cross-sectional view showing a state where the bezel and the vibration-proof rubber shown in FIG. 5 have been attached to a bumper.

FIG. 9 is a bottom view showing the appearance of the vibration-proof rubber shown in FIG. 8.

FIG. 10 is a side view showing a state where the bezel and the retainer shown in FIG. 3 have been attached to a bumper.

FIG. 11 is a back view of the bezel and the retainer shown in FIG. 10.

FIG. 12 is a schematic diagram showing a state where the insertion section of the vibration-proof rubber shown in FIG. 9 is inserted through the mounting hole in a bumper.

FIG. 13 is a schematic diagram showing a state where the insertion section of the vibration-proof rubber shown in FIG. 9 is inserted through the mounting hole in a bumper.

### DETAILED DESCRIPTION OF THE PREFERRED EMBODIMENTS

PTL 1: JP 2018-146564 A

As described in PTL 1, in this type of ultrasonic sensor, it is necessary to suppress, as much as possible, the transmission of vibrations between the ultrasonic sensor and the vehicle body component, such as a bumper, which is the attachment target, such that false detections caused by the transmission of vibrations are suppressed as much as possible.

The present disclosure has been made in consideration of the circumstances and the like illustrated above. That is, for example, the present disclosure provides a configuration that enables the transmission of vibrations between the ultrasonic sensor and the vehicle body component to which the ultrasonic sensor is attached to be suppressed as much as possible.

According to an aspect of the present disclosure, an ultrasonic sensor configured to be attached to a plate-shaped vehicle body component, comprising:
a tubular housing component that is inserted into a through-hole formed in the vehicle body component; and
a vibration-proof rubber that, as a result of being attached to the housing component, is interposed between the housing component and the vehicle body component in an attached state, in which the housing component is attached to the vehicle body component; in which
the vibration-proof rubber has three or more insertion sections that, in the attached state, as a result of being inserted through the through-hole, are held between an inner edge of the through-hole and the housing component in a radial direction that intersects a center axis line of the housing component, and
the three or more insertion sections are arranged so as to surround the center axis line.

Note that, in each section of the application document, reference signs are sometimes assigned to the respective elements in parentheses. In such cases, the reference signs merely indicate an example of a correspondence between the elements and the specific configurations described in the embodiment below. Therefore, the present disclosure is in no way limited by the listing of the reference signs.

### Embodiment

Hereinafter, an embodiment of the present disclosure will be described based on the drawings. Note that, when the various modifications that can be applied to a single embodiment inserted during a sequence of descriptions relating to the embodiment, there is a risk of hindering the understanding of the embodiment. Therefore, the modifications will not be inserted during the sequence of descriptions relating to the embodiment, and will be collectively described after the embodiment.

### Vehicle-mounted configuration

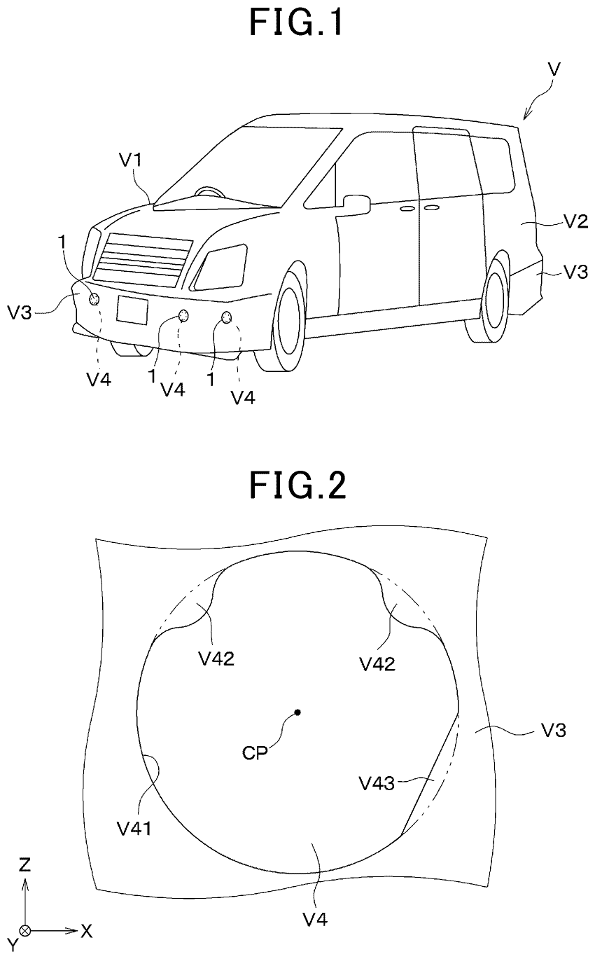

Referring to FIG. 1, in the present embodiment, an ultrasonic sensor 1 has a configuration of a vehicle-mounted clearance sonar, which has a vehicle V as an attachment target. That is, as a result of being mounted on the vehicle V, the ultrasonic sensor 1 has a configuration in which objects that are present in the surroundings of the vehicle V can be detected. The vehicle V is a so-called four-wheeled automobile, and includes a box-shaped vehicle body V1. The vehicle body V1 includes a vehicle body panel V2 and bumpers V3, which are plate-shaped vehicle body components constituting the exterior panels. The bumpers V3 are provided on each of a front end section and a rear end section of the vehicle body V1. In the present embodiment, the vehicle body panel V2 and the bumpers V3 are formed of a metallic plate material.

The ultrasonic sensor 1 is configured such that, as a result of being attached to the bumper V3 provided on the front end section of the vehicle body V1, that is, the front bumper, it is possible to detect objects that are present at the front and side-front of the vehicle V. Specifically, a plurality of (for example, four) ultrasonic sensors 1 are attached to the front bumper. The plurality of ultrasonic sensors 1 attached to the front bumper are each disposed at different positions in a vehicle width direction. Similarly, the ultrasonic sensor 1 is configured such that, as a result of being attached to the bumper V3 provided on the rear end section of the vehicle body V1, that is, the rear bumper, it is possible to detect objects that are present at the rear and side-rear of the vehicle V. A plurality of (for example, four) ultrasonic sensors 1 are also attached to the rear bumper.

The bumpers V3 are provided with mounting holes V4, which are through-holes for attaching the ultrasonic sensors 1. Here, a state where the ultrasonic sensor 1 is mounted on the vehicle V by being attached to a bumper V3 provided on the vehicle body VI is referred to as a “vehicle-mounted state” below. Note that the ultrasonic sensor 1 is attached to, and detached from, the bumper V3 in a state where the bumper V3 has been detached from the vehicle body V1. For this reason, the “attached state” in which the ultrasonic sensor 1 has been attached to the bumper V3, includes the “vehicle-mounted state”. That is, the “attached state” includes the vehicle-mounted state, and a state where the ultrasonic sensor 1 has been attached to the bumper V3 that has been detached from the vehicle body V1. The bumper V3 includes a bumper outer surface V31 and a bumper rear surface V32. The bumper outer surface V31 is the outer surface of the bumper V3, and is provided so as to face a bumper outer space SG, which is the space on the outer side of the vehicle V in the vehicle-mounted state. The bumper rear surface V32 is the surface on the rear side of the bumper outer surface V31, and is provided so as to face a bumper inner space SN, which is the space on the inner side of the vehicle V in the vehicle-mounted state. The mounting hole V4, as a result of being open at the bumper outer surface V31 and the bumper rear surface V32, is formed so as to penetrate through the thickness direction of the bumper V3.

Here, in the present embodiment, in order to prevent erroneous attachment of the ultrasonic sensor 1, as shown in FIG. 2, the mounting hole V4 is provided with bumper side protrusion sections V42, which protrude from an inner edge V41 toward an inner side, and a bumper side flat section V43. “Erroneous attachment” includes attachment of an ultrasonic sensor 1 having an incorrect part number, which is different from the part number that should be installed, to a mounting hole V4 of a specific vehicle V. Furthermore, “erroneous attachment” includes attaching an ultrasonic sensor 1 having the correct part number in a different attachment posture to the correct posture. The attachment posture is a rotational posture around a directional axis of the ultrasonic sensor 1 in the attached state. The “directional axis” is an imaginary straight line extending from the ultrasonic sensor 1 along the transmission/reception direction of the ultrasonic waves, and serves as a reference for directional angles. The “directional axis” may also be referred to as a directional center axis, or a detection axis.

The bumper side protrusion sections V42, which are the vehicle body side protrusion sections of the present disclosure, are formed as arc-shaped convex sections that are provided protruding toward a center position CP. The center position CP is the position of a center point of an arc of an arc-shaped portion in a front view, excluding the bumper side protrusion sections V42 and the bumper side flat section V43 of the mounting hole V4. Specifically, the center position CP is the position of the center point of the two-dot chain line in FIG. 2, which indicates the maximum value of the inner diameter of the mounting hole V4. In the present embodiment, the bumper side protrusion sections V42 are formed in a plurality of locations, and more specifically, in two locations. The two bumper side protrusion sections V42 are arranged in different positions in the circumferential direction of the mounting hole V4. More specifically, in the present embodiment, the two bumper side protrusion sections V42 are provided in symmetrical positions on both sides of a symmetry plane that passes through the center position CP and is parallel to the YZ plane in the drawing. In addition, the two bumper side protrusion sections V42 are arranged further on the positive Z axis side than the center position CP in the drawing. Specifically, the two bumper side protrusion sections V42 are arranged such that the two bumper side protrusion sections V42 and the center position CP form an isosceles inverted triangle with an apex angle of approximately 45 degrees, with the center position CP as the apex. The bumper side flat section V43 is formed having a shape that corresponds to a chord edge portion of a segmented circle. The bumper side flat section V43 is arranged further on the negative Z axis side than the center position CP in the drawing. Specifically, the bumper side flat section V43 is provided in a position that diagonally opposes the bumper side protrusion section V42 on the upper-left side in FIG. 2, with the center position CP therebetween.

### Ultrasonic Sensor

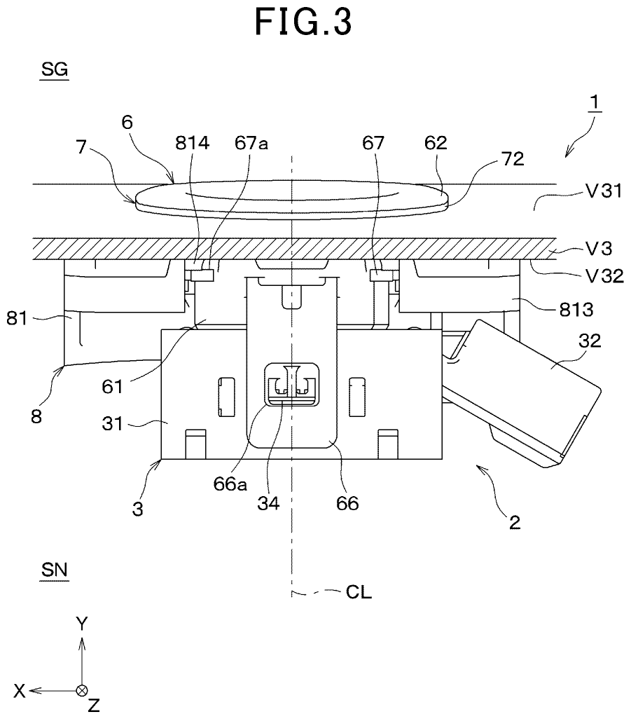

FIG. 3 shows one of the plurality of ultrasonic sensors 1 in the vehicle-mounted state. Hereinafter, the overall configuration of the ultrasonic sensor 1 according to the present embodiment will be described. Note that, for the convenience of the description, as illustrated in each drawing, a right-handed XYZ Cartesian coordinate system is set based on the direction in which gravity acts in the vehicle-mounted state. In the right-handed XYZ coordinate system that is illustrated, the up direction along a vertical upward direction is defined as the positive Z axis direction. The vertical upward direction is a direction that is parallel to the direction in which gravity acts, and in an opposite orientation to the direction in which gravity acts in a case where the vehicle V is stably placed on a horizontal surface in a drivable state. In the present embodiment, the up direction, that is, the positive Z axis direction, is substantially the same direction as the vertical upward direction. However, as described below, it goes without saying that the present disclosure is not limited to such a mode.

The ultrasonic sensor 1 is configured to be capable of transmitting and receiving ultrasonic waves. That is, the ultrasonic sensor 1 is configured to emit search waves, which are ultrasonic waves, along a center axis line CL toward the bumper outer space SG. Furthermore, the ultrasonic sensor 1 is configured to receive reception waves, which include reflected waves of search waves reflected by the objects present in the bumper outer space SG, that is, in the surroundings of the vehicle V, and generates and outputs a detection signal corresponding to the reception result of the reception waves. As shown in FIG. 3, in the illustrated right-handed XYZ coordinate system, the transmission direction of the search waves, which is parallel to the center axis line CL constituting the directional axis of the ultrasonic sensor 1, is defined as the positive Y axis direction. Hereinafter, the Y axis direction, which is parallel to the directional axis or the center axis line CL is referred to as the “axial direction”. Furthermore, of the two axial end sections of a member or portion that is provided extending in the axial direction, the end section on the positive Y axis direction side is sometimes referred to as the “leading end section in the axial direction”, and the end section on the negative Y axis direction side is sometimes referred to as the “base end section in the axial direction”. Furthermore, the dimension in the axial direction of a certain member or portion is simply referred to as the “axial direction dimension” below.

An arbitrary direction perpendicular to the axial direction is referred to as an “in-plane direction” below. The “in-plane direction” is a direction parallel to the XZ plane. The shape of a certain member or portion in a plane perpendicular to the center axis line CL, that is, the shape projected onto the XZ plane, is sometimes referred to as an “in-plane shape”. The “in-plane direction” includes a “radial direction” and a “circumferential direction”. The “radial direction” is a direction that radially extends from the center axis line CL. That is, the “radial direction” is a direction perpendicular to the center axis line CL, and a direction away from the center axis line CL. Specifically, the “radial direction” is the direction in which a half-line extends in a case where a half-line is drawn on a virtual plane perpendicular to the center axis line CL, starting from the intersection of the virtual plane and center axis line CL. In other words, the “radial direction” is the radial direction of a virtual circle in a case where a virtual circle is drawn on the virtual plane and centered on the intersection of the virtual plane and the center axis line CL. Of the radial direction, the direction away from the center axis line CL is referred to as the “centrifugal direction” below. In contrast, of the radial direction, the direction toward the center axis line CL is referred to as the “centripetal direction” below. Furthermore, the “circumferential direction” is the circumferential direction of the virtual circle surrounding the center axis line CL described above.

In the present embodiment, in the vehicle-mounted state, the ultrasonic sensor 1 is mounted on the vehicle V such that the center axis line CL intersects the thickness direction of the bumper V3 at the attachment position. The “attachment position” is the position at which the ultrasonic sensor 1 is attached to the bumper V3, and is typically the center position CP of the mounting hole V4. Specifically, in the vehicle-mounted state, the ultrasonic sensor 1 is attached to the bumper V3 such that the center axis line CL becomes substantially horizontal. On the other hand, in the attached state, the bumper V3 is configured such that the bumper outer surface V31 and the bumper rear surface V32 are inclined with respect to a vertical plane.

Hereinafter, each section that constitutes the ultrasonic sensor 1 will be described in order with reference to FIGS. 3 to 5. The sensor main body 2 that constitutes the main body portion of the ultrasonic sensor 1 includes a sensor case 3, an ultrasonic microphone 4, a cushion member 5, a bezel 6, and a vibration-proof rubber 7. The sensor main body 2 is attached to the bumper V3 using a retainer 8. That is, the ultrasonic sensor 1 in the attached state or the vehicle-mounted state is constituted by the sensor case 3, the ultrasonic microphone 4, the cushion member 5, the bezel 6, the vibration-proof rubber 7, and the retainer 8.

### Sensor Case

The sensor case 3, which constitutes the housing of the ultrasonic sensor 1, that is, the sensor main body 2, is formed of a hard synthetic resin such as polybutylene terephthalate, ABS resin, polypropylene, polycarbonate, or polystyrene. The sensor case 3 includes a box-shaped section 31, a connector section 32, and a microphone support section 33. The box-shaped section 31, the connector section 32, and the microphone support section 33 are seamlessly and integrally formed by injection molding. The box-shaped section 31 has a box-shaped outer shape that, in the attached state, has the longitudinal direction in the X axis direction, and is thin in the Y axis direction. A circuit board (not shown) that is electrically connected to the ultrasonic microphone 4 via a connection wire is accommodated inside the box-shaped section 31.

The connector section 32 is provided so as to extend from one end section of the box-shaped section 31 in the longitudinal direction (that is, from the right end section in FIGS. 3 to 5) toward a substantially horizontal and diagonally rearward direction in the vehicle-mounted state. That is, in the attached state, the connector section 32 is provided extending in a direction away from the bumper V3. The connector section 32 is configured as a receptacle connector that can be attached to, and detached from, a plug connector (not shown) provided at the end of a wire harness for electrical connection with an external device, such as an ECU. ECU is an abbreviation for electronic control unit.

The microphone support section 33 is provided extending in the axial direction from the box-shaped section 31. The microphone support section 33 has a tubular shape that surrounds the center axis line CL. In the present embodiment, the microphone support section 33 is formed having a cylindrical shape with the center axis line CL as the axis center.

The box-shaped section 31 is provided with a pair of bezel locking protrusions 34. The bezel locking protrusions 34 are small protrusions for locking the bezel 6 to the sensor case 3, and are provided protruding in the centrifugal direction from the outer wall surface of the box-shaped section 31. The pair of bezel locking protrusions 34 are arranged at symmetrical positions on both sides of the center axis line CL.

### Ultrasonic Microphone

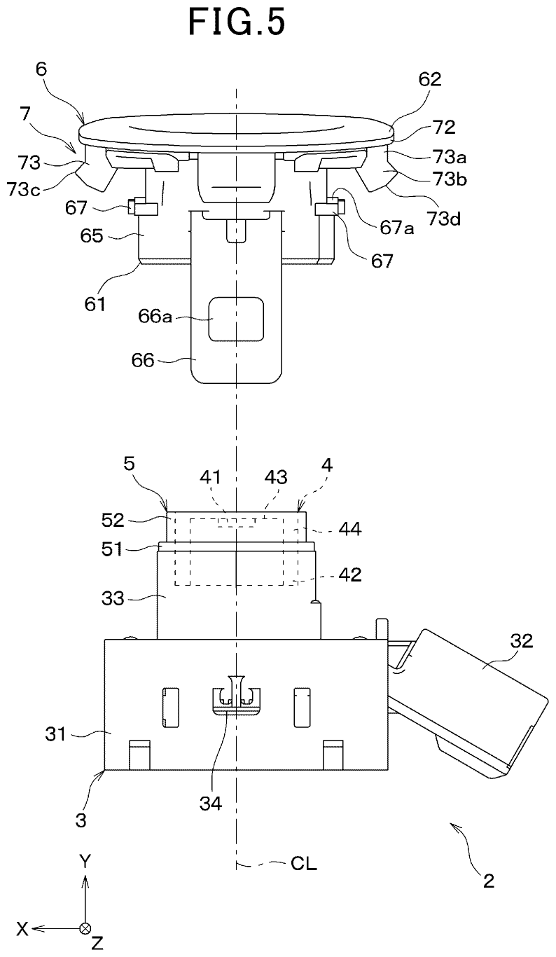

As shown in FIG. 5, the ultrasonic microphone 4 has a column-shaped outer shape that is provided extending along the axial direction. Specifically, in the present embodiment, the ultrasonic microphone 4 is formed having a substantially circular column shape with the center axis line CL as the axis center. The ultrasonic microphone 4 includes an ultrasonic element 41 and a microphone case 42. The ultrasonic element 41 is a so-called electromechanical conversion element, and is composed of a thin-film piezoelectric element or the like. The ultrasonic element 41 is accommodated inside the microphone case 42.

The microphone case 42, which constitutes the housing of the ultrasonic microphone 4, is formed having a closed-bottom tubular shape by a metallic material such as aluminum. Specifically, the microphone case 42 includes a diaphragm 43 and a side plate section 44. The diaphragm 43 is formed with a thin plate shape having the thickness direction in the axial direction. The diaphragm 43 is provided so as to close the leading end section of the cylinder-shaped side plate section 44 in the axial direction. The outer surface of the diaphragm 43 that faces the bumper outer space SG in the attached state or the vehicle-mounted state is formed having a smooth flat shape. The inner surface of the diaphragm 43, which is the surface on the rear side of the outer surface, has the ultrasonic element 41 adhesively fixed thereto.

### Cushion Member

As shown in FIG. 5, the cushion member 5 is formed having a stepped tubular shape that surrounds the center axis line CL. Specifically, the cushion member 5 includes a base section 51 and a microphone housing section 52. The base section 51, which is provided on the base end section in the axial direction of the cushion member 5, is formed having a flat plate shape and a ring shape. That is, the base section 51 is provided protruding in the centrifugal direction from the base end section in the axial direction of the microphone housing section 52, which is formed having a cylindrical shape. The microphone housing section 52 is configured so as to accommodate the portion of the ultrasonic microphone 4 that protrudes from the microphone support section 33 over substantially the entire axial direction. That is, the microphone housing section 52 has a columnar internal space that corresponds to the outer shape of the ultrasonic microphone 4 so as to cover the side surface of the ultrasonic microphone 4.

The cushion member 5 is seamlessly and integrally formed by a synthetic resin-based elastic material such as silicone rubber. Further, the cushion member 5 is configured so as to be interposed between the ultrasonic microphone 4 and the bezel 6 as a result of the base section 51 abutting the microphone support section 33 in the axial direction, while the microphone housing section 52 also covers the side surface of the ultrasonic microphone 4. That is, the cushion member 5 is provided so as to suppress the transmission of vibrations between the ultrasonic microphone 4 and the bezel 6.

### Bezel

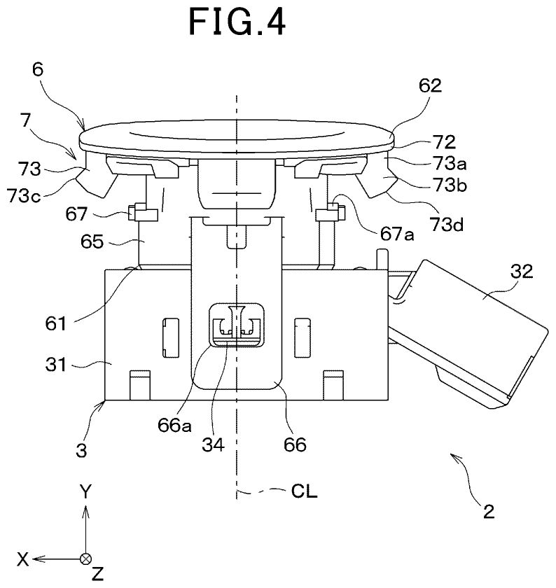

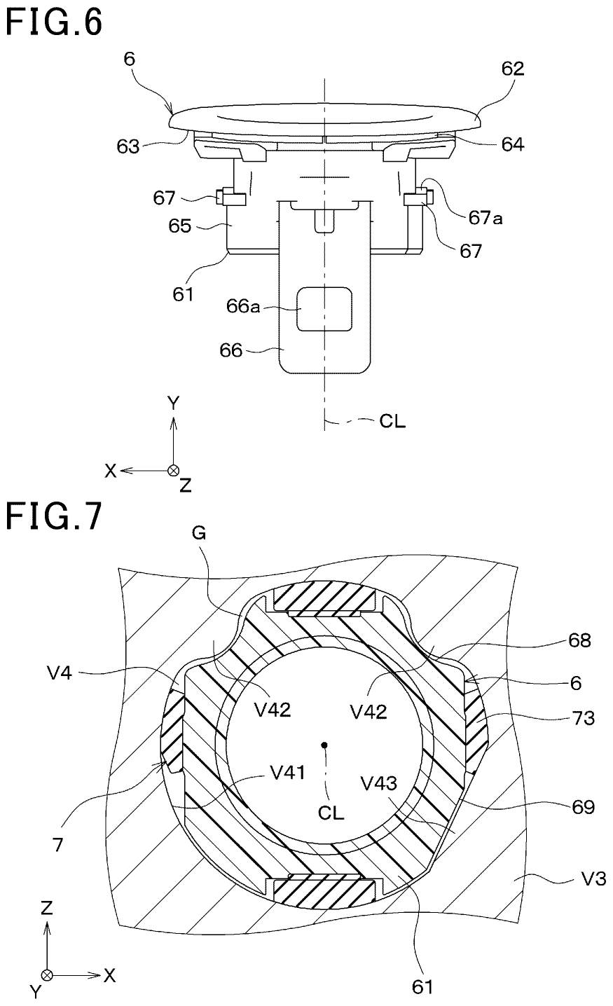

The configuration of the bezel 6, which is a housing component that forms the housing of the ultrasonic sensor 1 with the sensor case 3, will be described with reference to FIGS. 3 to 8. The bezel 6 is a housing component used for attaching the ultrasonic sensor 1 to the bumper V3, and is formed having a tubular shape by a hard synthetic resin. FIGS. 4 to 8 illustrate a state where the center axis of the tubular shape of the bezel 6 is made to coincide with the center axis line CL. The bezel 6 has a tubular section 61 and a flange section 62. The tubular section 61 and the flange section 62 are seamlessly and integrally formed by the same material.

The tubular section 61 has a tubular shape that surrounds the center axis line CL, or more specifically, is formed having a substantially cylindrical shape. In the attached state, the tubular section 61 is provided so as to surround the ultrasonic microphone 4 and the cushion member 5, while also being inserted in the mounting hole V4. The tubular section 61 has a slightly smaller outer diameter than the inner diameter of the mounting hole V4, and has a slightly larger inner diameter than the outer diameter of the microphone support section 33 and the cushion member 5.

The flange section 62 serves as a slippage-preventing protrusion section when the tubular section 61 is inserted into the mounting hole V4 in order to attach the sensor main body 2 or the bezel 6 to the bumper V3, and is provided so as to protrude at the leading end section, which is one end section in the axial direction of the tubular section 61, along the centrifugal direction. Specifically, the flange section 62 is configured as a ring-shaped eave section that is continuous in the circumferential direction, having a larger outer diameter than the inner diameter of the mounting hole V4. Further, in the attached state, the flange section 62 is provided facing the surrounding portion of the mounting hole V4 of the bumper outer surface V31, with the vibration-proof rubber 7 interposed therebetween. In the present embodiment, due to the fact that the center axis line CL intersects the thickness direction of the bumper V3 at the attachment position, the flange section 62 is formed such that the protruding direction intersects a virtual plane having the center axis line CL as the normal to the plane. That is, the back surface 63 of the flange section 62 is formed having a flat plane shape in which the normal direction is slightly inclined (for example, by a few degrees) with respect to the center axis line CL.

In the tubular section 61, a spacer mounting groove 64, which is a groove section for attaching the vibration-proof rubber 7, is provided at a position adjacent to the flange section 62 in the axial direction so as to be open in the protruding direction of the flange section 62. That is, the spacer mounting groove 64 is disposed on the leading end section of the tubular section 61 in the axial direction. The spacer mounting groove 64 is provided extending over the entire bezel 6 in the circumferential direction. A main body portion 65, which is a portion further on the base end side than spacer mounting groove 64 in the axial direction of the tubular section 61, is provided extending along the center axis line CL.

The main body section 65 is provided with a pair of sensor locking pieces 66. The pair of sensor locking pieces 66 are arranged at symmetrical positions on both sides of the center axis line CL. The sensor locking pieces 66 re thin plate-shaped tongue pieces having their thickness direction in the radial direction, and are formed in a cantilever shape extending from the main body section 65 toward the base end side in the axial direction. That is, the sensor locking piece 66 is configured such that the leading end section in the axial direction is a fixed end, the base end section in the axial direction is a free end, with the free end being elastically deformable in a mode that moves in the radial direction. The free end side of the sensor locking piece 66 is provided with a locking hole 66a that penetrates through the sensor locking piece 66 in the thickness direction. The locking hole 66a is formed so as to detachably engage a bezel locking protrusion 34 provided on the microphone support section 33. The main body portion 65 is provided with the same number of sensor locking pieces 66 as bezel locking protrusions 34, in positions corresponding to the bezel locking protrusions 34 in the circumferential direction.

Furthermore, the main body section 65 is provided with a pair of retainer holding protrusions 67. The pair of retainer holding protrusions 67 are arranged at symmetrical positions on both sides of the center axis line CL, while also protruding in the centrifugal direction. The retainer holding protrusion 67 is a rib-shaped protrusion, and is provided extending substantially parallel to the flange section 62. That is, a retainer abutting surface 67a, which is the surface of the retainer holding protrusion 67 facing the flange section 62, and the rear surface 63 of the flange section 62, are provided so as to be substantially parallel. The retainer abutting surface 67a is formed having a smooth flat shape.

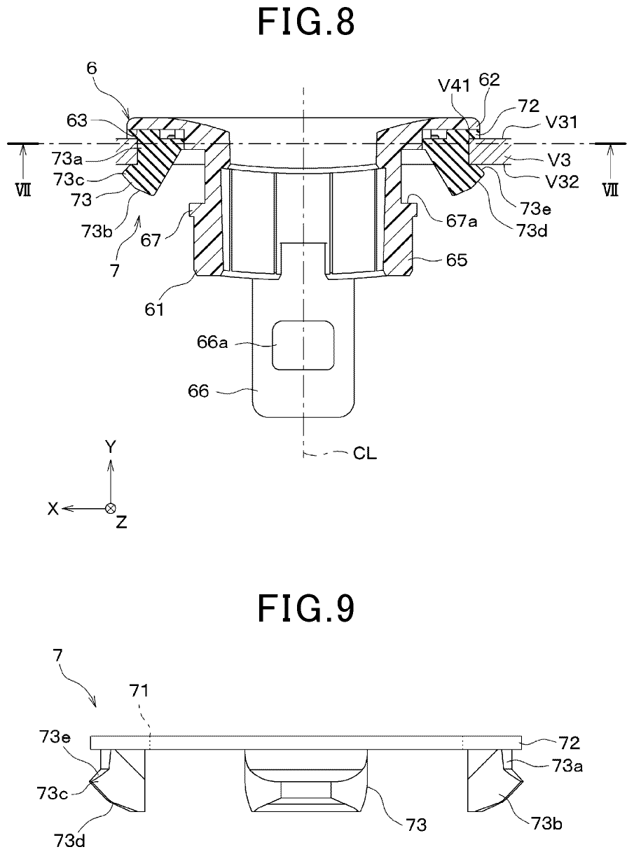

FIG. 7 is a cross-sectional view along VII-VII in FIG. 8. As shown in FIG. 7, the bezel 6 has sensor side concave sections 68 and a sensor side flat section 69. The sensor side concave sections 68 and the sensor side flat section 69 are provided in the tubular section 61. The sensor side concave sections 68 are recessed so as to match the protruding shape of the bumper side protrusion sections V42, and such that the bumper side protrusion sections V42 are engaged in the attached state. The sensor side concave sections 68 are arranged in positions that, in the attached state, correspond to the positions of the bumper side protrusion sections V42 in the circumferential direction. In the present embodiment, two sensor side concave sections 68 are provided in the tubular section 61 so as to correspond with the two bumper side protrusion sections V42 that are provided on the mounting hole V4. Furthermore, the sensor side flat section 69 is arranged in a position that, in the attached state, corresponds to the position of the bumper side flat section 43. The sensor side flat section 69 is formed having a shape that corresponds to that of the bumper side flat section V43.

### Vibration-Proof Rubber

The specific configuration of the vibration-proof rubber 7 according to the present embodiment will be described with reference to FIGS. 7 to 9. The vibration-proof rubber 7 is configured to be interposed between the bezel 6 and the bumper 3 in the attached state as a result of being attached to the bezel 6. The vibration-proof rubber 7 is seamlessly and integrally formed by a synthetic resin-based elastic material such as silicone rubber. The vibration-proof rubber 7 is formed having a ring shape with a circular spacer through-hole 71 that is provided penetrating through the center. Specifically, the vibration-proof rubber 7 includes an elastic spacer section 72 and insertion sections 73.

The elastic spacer section 72 is a thin plate-shaped portion, that is, a circular plate-shaped portion, having its thickness direction along the axial direction, and is formed in an O-ring shape surrounding the spacer through-hole 71 so as to be interposed between the flange section 62 and the bumper V3 in the attached state. Specifically, the elastic spacer section 72 has a thickness corresponding to the axial direction dimension of the spacer mounting groove 64 provided in the bezel 6, an inner diameter corresponding to the inner diameter of the spacer mounting groove 64, and an outer diameter that is substantially equal to that of the flange section 62.

The insertion section 73 is provided projecting in the axial direction from the elastic spacer section 72. As shown in FIGS. 7 and 8, in the attached state, the insertion section 73 is provided so as to abut the inner edge V41 of the mounting hole V4 in the centrifugal direction. That is, the insertion section 73 is configured such that, in the attached state, as a result of being inserted through the mounting hole V4 and engaging with the inner edge V41, the bezel 6, to which the vibration-proof rubber 7 has been attached, is held by the bumper V3. Furthermore, the insertion section 73 is held between the inner edge V41 and the bezel 6 in the radial direction by being inserted through the mounting hole V4 in the attached state. Further, as shown in FIG. 8, the insertion section 73 is formed such that the axial direction dimension is larger than the thickness of the bumper V3.

The vibration-proof rubber 7 has three or more insertion sections 73. As shown in FIG. 7, the insertion sections 73 are arranged so as to surround the center axis line CL. In the present embodiment, four insertion sections 73 are arranged at equal intervals in the circumferential direction. Furthermore, the insertion sections 73 are provided in different positions in the circumferential direction to the bumper side protrusion sections V42 in the attached state. In addition, one of the four insertion sections 73 (that is, the uppermost insertion section 73 in FIG. 7), is provided between the pair of bumper side protrusion sections V42 in the circumferential direction in the attached state. Further, the vibration-proof rubber 7 is configured so as to provide a centering function of the bezel 6 with respect to the mounting hole V4 in the attached state. “Centering” refers to alignment of the center position CP of the mounting hole V4 shown in FIG. 2, and the center axis line CL of the bezel 6. That is, the four insertion sections 73 are provided such that, as a result of biasing and centering the tubular section 61 from four directions, a gap G between the tubular section 61 and the inner edge V41 of the mounting hole V4 is formed over the entire circumferential direction.

Referring to FIGS. 8 and 9, the insertion section 73 includes an axial direction protrusion section 73a and a holding claw section 73b. The axial direction protrusion section 73a is provided protruding from the elastic spacer section 72 in the axial direction so as to be accommodated inside the mounting hole V4 in the attached state. The holding claw section 73b extends from the axial direction protrusion section 73a along the axial direction. The insertion section 73 is configured such that the holding claw section 73b elastically deforms in the centrifugal direction as a result of the axial direction protrusion section 73a being pressed in the centripetal direction by the inner edge V41 of the mounting hole V4. Specifically, in the present embodiment, the radius from the center of the vibration-proof rubber 7 to the outer edge of the axial direction protrusion section 73a is set to a slightly larger radius than that of the mounting hole V4.

The holding claw section 73b is provided with a radial direction protrusion section 73c that protrudes in the centrifugal direction. The radial direction protrusion section 73c has a mounting hole abutting surface 73d and a holding surface 73e. The mounting hole abutting surface 73d is formed as an inclined surface that abuts the inner edge V41 when the insertion section 73 is inserted into the mounting hole V4, which causes the holding claw section 73b to become biased in the centripetal direction. The holding surface 73e is formed as an inclined surface that, in the attached state, faces the opening portion of the inner edge V41 on the bumper rear surface V32 side.

### Retainer

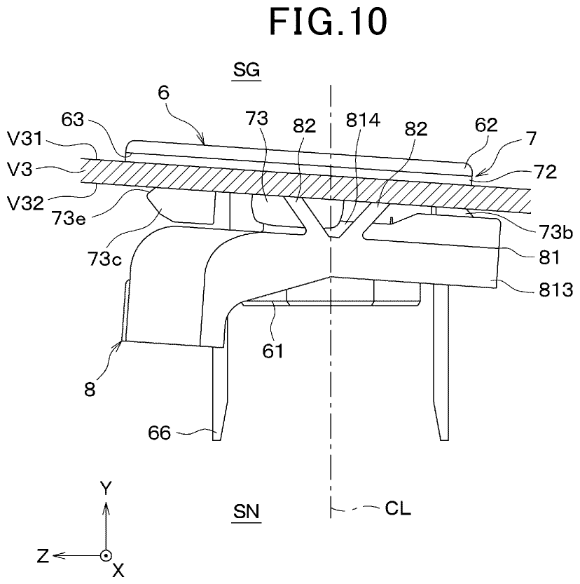

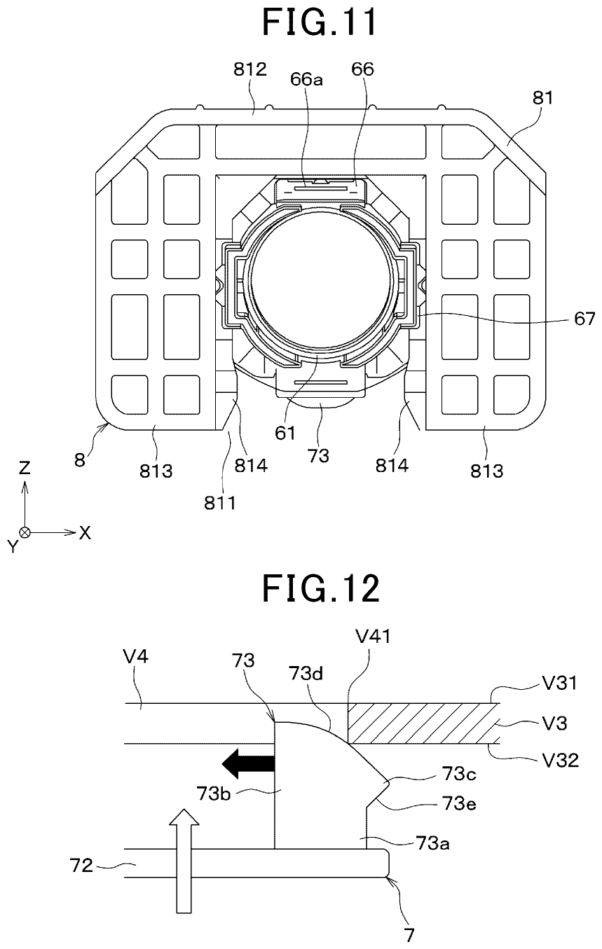

The configuration of the retainer 8 will be described with reference to FIGS. 3 to 9, as well as FIGS. 10 and 11. The retainer 8 is a housing component used for attaching the ultrasonic sensor 1, that is, the sensor main body 2, to the bumper V3, and is seamlessly and integrally formed by a hard synthetic resin. Specifically, the retainer 8 is configured so as to achieve the attached state as a result of being inserted and held between the bumper V3 and the retainer holding protrusions 67 provided on the bezel 6 of the sensor main body 2 in a temporarily attached state. The “temporarily attached state” is a state in which the retainer 8 has been detached from the vehicle-mounted state shown in FIG. 3, or the attached state. That is, the “temporarily attached state” is a state in which the sensor main body 2 is held by the bumper V3 due to the engagement between the inner edge V41 of the mounting hole V4 and the insertion section 73 of the vibration-proof rubber 7.

The retainer 8 has a retainer main body 81 and elastic sections 82. As shown in FIG. 11, the retainer main body 81 is formed having a letter-U shape provided with an opening section 811 that opens toward the negative Z direction in the drawing. A joining section 812 on the opposite side to the opening section 811 is provided extending in the X axis direction in the drawing, which is the width direction of the retainer main body 81. The retainer 8 is symmetrically formed with respect to a plane that passes through the center of the width direction of the retainer main body 81, which is a letter U-shaped section, and that is parallel to the YZ plane in the drawing. Extension sections 813 that are provided extending toward the negative Z axis direction in the drawing are provided on both sides of the joining section 812. That is, the opening section 811 is provided at a leading end section in the extending direction of the pair of extension sections 813, which are provided so as to be parallel to each other. On the other hand, the base end sections of the pair of extension sections 813 in the extending direction are joined to each other by the joining section 812.

Each of the pair of extension sections 813 has a guide section 814. The guide section 814 is formed with a thin plate shape having its thickness direction along the axial direction. The guide section 814 is provided protruding toward the inner side along the width direction of the retainer main body 81, and is provided extending from a position that corresponds to the opening section 811 toward the opposite direction to the extending direction of the extension section 813. The guide section 814 is formed so as to guide the insertion of the extension section 813 through to a square groove-shaped space formed between the retainer holding protrusions 67 and the bumper V3, when the retainer 8 is moved in the extending direction of the retainer holding protrusion 67 while being attached to the bezel 6. That is, the guide section 814 is provided abutting the retainer abutting surface 67a, which is a surface of the retainer holding protrusion 67, in a state where the tubular section 61 of the bezel 6 is inserted inside the opening section 811.

As shown in FIG. 10, the elastic sections 82 are cantilever-shaped plate spring sections, and are provided protruding from the retainer main body 81 along the axial direction. The elastic section 82 is configured so as to abut the bumper rear surface V32 while also becoming elastically deformed in the attached state, in which the retainer 8 is held between the retainer abutting surface 67a of the bezel 6 and the bumper rear surface V32. Therefore, the elastic section 82 is formed such that, as a result of being pressed toward the negative Y axis direction in the drawing and becoming elastically deformed along the axial direction, an elastic force is generated in the positive Y axis direction in the drawing. In the present embodiment, the elastic section 82 is provided so as to protrude from each of the pair of extension sections 813 toward the positive Y axis side in the drawing. Specifically, the elastic section 82 is provided extending from a substantially center section of the extension section 813 in the extending direction toward a direction that is inclined with respect to the Y axis. In addition, on one of the extension sections 813, a pair of elastic sections 82 is provided in a gull-wing shape in a side view. That is, the retainer 8 has four elastic sections 82.

In this way, the elastic section 82 is formed so as to generate an elastic force in the direction toward the bumper V3 in a state where the tubular section 61 of the bezel 6 is inserted into the mounting hole V4, and the retainer main body 81 is inserted into the space between the retainer holding protrusion 67 and the bumper V3. Further, the retainer 8 is configured so as to be held between the bumper V3 and the tubular section 61 by an elastic force due to accommodating the tubular section 61 inside the opening section 811 while also sliding along the bumper rear surface V32 and becoming attached to the bezel 6.

### Effects

Hereinafter, the attachment method of the ultrasonic sensor 1 to the bumper V3, and the attached state will be described with reference to the drawings, together with the effects that are provided by the configuration of the present embodiment. For the simplicity of the description, the following attachment method or attachment process will be described using a right-handed XYZ Cartesian coordinate system based on the vehicle-mounted state as shown in the drawings. However, as mentioned above, the ultrasonic sensor 1 is attached to, and detached from, the bumper V3 in a state where the bumper V3 has been detached from the vehicle body V1. For this reason, in an actual attachment method or attachment process, the positive Z axis direction may differ from the upward direction.

First, as shown in FIG. 5, the cushion member 5 is attached to the sensor case 3 so as to cover the ultrasonic microphone 4. Furthermore, the vibration-proof rubber 7 is attached to the bezel 6. Specifically, the O-ring shaped elastic spacer section 72 of the vibration-proof rubber 7 is fitted into the spacer mounting groove 64 of the bezel 6. Then, the cushion member 5 that is covering the ultrasonic microphone 4 is inserted inside the cylinder shape of the tubular section 61 of the bezel 6, to which the vibration-proof rubber 7 has been attached. As a result, the locking hole 66a in the sensor locking piece 66 provided on the tubular section 61 and the bezel locking protrusion 34 provided on the sensor case 3 become engaged. In this way, the sensor main body 2 shown in FIG. 4 is formed as a result of the bezel 6, to which the vibration-proof rubber 7 has been attached, being assembled with the sensor case 3, to which the cushion member 5 has been attached. In the sensor main body 2, the cushion member 5 surrounds the ultrasonic microphone 4, while being accommodated in the tubular section 61 of the bezel 6. That is, a state is obtained in which the cushion member 5 is interposed between the ultrasonic microphone 4 and the bezel 6. As a result, the transmission of vibrations between the ultrasonic microphone 4 and the bezel 6 can be adequately suppressed.

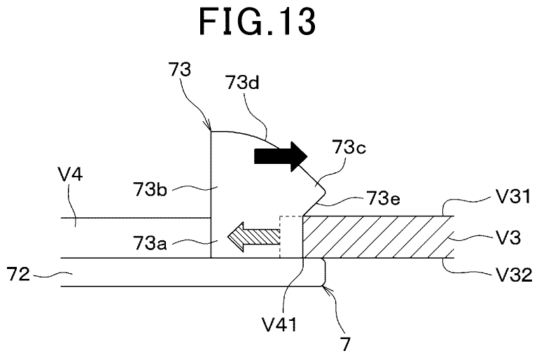

The sensor main body 2 shown in FIG. 4 is inserted into the mounting hole V4 from the bumper outer space SG side led by the connector section 32, until the elastic spacer section 72 of the vibration-proof rubber 7 abuts the bumper outer surface V31. At this time, in the process of the tubular section 61 of the bezel 6 being inserted into the mounting hole V4, the mounting hole abutting surface 73d, which is the leading surface in the insertion direction of the insertion section 73 of the vibration-proof rubber 7, abuts the inner edge V41 of the mounting hole V4. FIG. 12 shows the state at this time. Note that, for the simplicity of the illustration, in FIG. 12, and in FIG. 13 described below, the illustration of components other than the bumper V3 and the vibration-proof rubber 7 have been omitted. The white arrow in FIG. 12 shows the relative movement of the vibration-proof rubber 7 with respect to the bumper V3. In this way, as a result of the mounting hole abutting surface 73d abutting the inner edge V41, the insertion section 73 is elastically deformed in the direction indicated by the solid black arrow in FIG. 12, in a mode where the axial direction protrusion section 73a is fixed end, and the holding claw section 73b, which becomes the free end, approaches the inner side, that is, the center axis line CL.

When the holding claw section 73b passes through the mounting hole V4, the elastic deformation toward the inner side of the insertion section 73 described above is restored. Then, as shown in FIG. 8, a state is formed in which the bezel 6 is held by the bumper V3 by the flange section 62 and the insertion section 73. As a result, the sensor main body 2 adopts the temporarily attached state. In the temporarily attached state, as a result of the elastic spacer section 72 and insertion section 73 of the vibration-proof rubber 7 being in rubber-elastic contact with the inner edge V41 of the mounting hole V4 of the bumper V3 and the surrounding portions thereof, the components can be adequately held in the following steps until the retainer 8 is attached.

In the temporarily attached state, the axial direction protrusion section 73a of the insertion section 73 faces and abuts the inner edge V41 of the mounting hole V4 in the centrifugal direction. At this time, the radius of the mounting hole V4 is slightly smaller than the radius from the center of the O-ring shaped elastic spacer section 72 of the vibration-proof rubber 7 to the outer edge of the axial direction protrusion section 73a. For this reason, as shown in FIG. 13, the axial direction protrusion section 73a is pressed in the centripetal direction by the inner edge V41, as indicated by the diagonally hatched arrow in the drawing. Note that the portion of the axial direction protrusion section 73a that is elastically deformed as a result of being bitten into by the inner edge V41 is indicated by a dashed line in FIG. 13. Then, the insertion section 73 falls toward the outside as indicated by the solid black arrow in the drawing. That is, the insertion section 73 is elastically deformed in a mode where the axial direction protrusion section 73a is the fixed end, and the holding claw section 73b, which is the free end, moves outward, that is, in the centrifugal direction. As a result, the temporarily attached state is achieved in which the sensor main body 2 is held by the bumper V3. In the temporarily attached state, even when an operator changes the posture of the bumper V3, for example, the sensor main body 2 typically does not detach from the bumper V3 even when the bumper outer surface V31 is oriented vertically downward, and the temporarily attached state can be adequately maintained.

As described above, after the sensor main body 2 has adopted the temporarily attached state, the retainer 8 is attached to the bezel 6, that is, the sensor main body 2. Specifically, the retainer 8 is firstly set such that the bezel 6 of the sensor main body 2, which is in the temporarily attached state, is inserted into the opening section 811. Then, the retainer 8 is made to slide along the bumper rear surface V32 while being pushed in until the bezel 6 and the joining section 812 of the retainer 8 are abutting or approaching each other. As a result, the extension sections 813 of the retainer 8, that is, the guide sections 814, are inserted into the space between the retainer abutting surface 67a of the bezel 6 and the bumper rear surface V32. At this time, as a result of the elastic deformation of the elastic section 82, the retainer 8 is elastically held between the retainer holding protrusions 67 of the bezel 6 and the bumper rear surface V32. In this way, as a result of the sensor main body 2, which has adopted the temporarily attached state, being attached to the retainer 8, as shown in FIG. 3, the attached state or the vehicle-mounted state, in which the ultrasonic sensor 1 is attached to the bumper V3, is achieved.

In the present embodiment, the vibration-proof rubber 7 is interposed between the bumper V3 and the sensor main body 2 in the temporarily attached state. Specifically, in the axial direction, the elastic spacer section 72 is held between the bumper V3 and the flange section 62 of the bezel 6, which is provided in the sensor main body 2. On the other hand, in the radial direction, the insertion section 73 is inserted and elastically held between the tubular section 61 of the bezel 6, which is provided in the sensor main body 2, and the inner edge V41 of the mounting hole V4, which is provided in the bumper V3. Further, a state in which the tubular section 61 is inserted through the mounting hole V4 is maintained via the elastic deformation of the insertion section 73. According to such a configuration, it is possible to suppress, as much as possible, the transmission of vibrations between the ultrasonic sensor 1 and the bumper V3, which serves as the vehicle body component representing the attachment target of the ultrasonic sensor 1. Specifically, it is possible to suppress, as much as possible, the occurrence of erroneous detection due to the transmission of vibrations with the bumper V3, which is more likely to occur in a case where the bumper V3 is formed of a metallic plate material having high vibration transmission properties. In addition, the occurrence of transmission of vibrations due to foreign matter, such as water, ice, or sand, becoming caught between the sensor main body 2 and the bumper V3, and the occurrence of erroneous detection caused by the vibrations, can be suitably suppressed.

In the present embodiment, in the temporarily attached state, the attached state, or the vehicle-mounted state, the insertion sections 73 that are interposed in a rubber-elastic manner between the inner edge V41 of the mounting hole V4 and the bezel 6 are provided in three or more locations in the circumferential direction so as to surround the center axis line CL. As a result, the centering function of the bezel 6, that is, the ultrasonic sensor 1, with respect to the mounting hole V4 is provided in the attached state. Furthermore, a narrow gap G is formed between the tubular section 61 and the inner edge V41 of the mounting hole V4 in those locations other than the locations in which the insertion sections 73 are formed in the circumferential direction. Therefore, interference, that is, contact, between the inner edge V41 and the bezel 6 in the radial direction can be adequately avoided in those locations where the insertion sections 73 are not provided. Therefore, according to such a configuration, the inadvertent transmission of vibrations between the ultrasonic sensor 1 and the bumper V3 due to the contact between the inner edge V41 and the bezel 6 in the radial direction can be adequately suppressed. Specifically, it is possible to adequately suppress the occurrence of erroneous detection due to the transmission of vibrations with the bumper V3, which is more likely to occur in a case where the bumper V3 is formed of a metallic plate material having high vibration transmission properties.

As described above, in the attached state or the vehicle-mounted state, the cushion member 5, the bezel 6, and the vibration-proof rubber 7 are interposed between the ultrasonic microphone 4 and the bumper V3. Specifically, the cushion member 5 is held between the ultrasonic microphone 4 and the bezel 6. Furthermore, the vibration-proof rubber 7 is held between the bezel 6 and the bumper V3. Therefore, according to the present embodiment, it is possible to adequately suppress the occurrence of erroneous detection due to the transmission of vibrations with the bumper V3, which is more likely to occur in a case where the bumper V3 is formed of a metallic plate material having high vibration transmission properties.

In the present embodiment, a plurality, that is, a pair of bumper side protrusion sections V42, and the bumper side flat section V43 are provided in predetermined positions in the circumferential direction of the mounting hole V4. Furthermore, the tubular section 61 of the bezel 6 is formed having the sensor side concave sections 68 and the sensor side flat section 69 so as to correspond to the shapes and circumferential direction arrangement of the bumper side protrusion sections V42 and the bumper side flat section V43. The insertion sections 73 are arranged in different positions in the circumferential direction to the bumper side protrusion sections V42 in the attached state. Specifically, one of the plurality of insertion sections 73 is provided between the pair of bumper side protrusion sections V42 in the circumferential direction in the attached state. Further, the bezel 6 is configured such that the sensor side concave sections 68 engage the bumper side protrusion sections V42 in the attached state. As a result, it is possible to adequately avoid erroneous attachment and improve installation workability, while also adequately suppressing the occurrence of erroneous detections caused by the transmission of vibrations with the bumper V3. Specifically, errors in the rotational posture of the ultrasonic sensor 1 around the directional axis in the vehicle-mounted state can be adequately avoided in a case where, as described above, the thickness direction of the bumper V3 and the center axis line CL constituting the directional axis intersect, and in a case where the directivity is not symmetrical around the directional axis. A case where the directivity is not symmetrical around the directional axis is, for example, a case where the directivity width is different in the horizontal direction and the vertical direction, and more specifically, a case where the in-plane shape of the diaphragm 43 is an elliptical shape. An alternative case, for example, is a case where the ultrasonic microphone 4 has so-called biased directivity.

### Modifications

The present disclosure is not limited to the embodiment described above. Therefore, the embodiment described above may be modified as appropriate. Hereinafter, representative modifications will be described. In the description of the modifications below, the differences with the embodiment described above will mainly be described. Furthermore, those parts that are the same or equivalent as each other in the embodiment described above and the modifications will be referred to by the same reference signs. Therefore, in the following description of the modifications, in terms of the components having the same reference signs as those of the above embodiment, the description in the above embodiment may be cited as appropriate, unless there is a technical contradiction or a specific additional description.

The attachment target of the ultrasonic sensor 1 is not limited to the bumper V3. Specifically, for example, the ultrasonic sensor 1 may also be attached to the vehicle body panel V2. That is, the mounting holes V4 may also be provided in the vehicle body panel V2. Therefore, the present disclosure provides the same superior effects as those described above even in cases where the ultrasonic sensor 1 is attached to the metallic vehicle body panel V2. Furthermore, the ultrasonic sensor 1 is not limited to a configuration that enables transmission and reception of ultrasonic waves. Therefore, for example, the ultrasonic sensor 1 may also have a configuration in which only transmission of ultrasonic waves is possible. Alternatively, for example, the ultrasonic sensor 1 may only have a receiving function that receives reflected waves, which are waves obtained as a result of search waves, which are ultrasonic waves transmitted from another ultrasonic transmitter, being reflected by objects that are present in the surroundings.

In the embodiment described above, the Y axis direction has been assumed to be the horizontal direction. As a result, the up direction, that is, the positive Z axis direction, is substantially the same direction as the vertical upward direction. However, the present disclosure is not limited to such a mode. That is, the up direction may be a direction that forms a predetermined small acute angle a with the vertical upward direction. The acute angle a in this case is, for example, 10 degrees or less. Therefore, depending on the shape of the bumper V3, the mounting position of the ultrasonic sensor 1, and the like, the positive Z axis direction can sometimes be the same direction as the vertical upward direction, or in a direction that intersects the vertical upward direction. Similarly, the positive Y axis direction can sometimes be in the same direction as the horizontal direction, or in a direction that intersects the horizontal direction.

The shape, number, and installation positions of the bumper side protrusion sections V42 in the mounting hole V4 may also be modified as appropriate. Specifically, for example, the shape of the bumper side protrusion sections V42 is not limited to an arc shape, and may be a triangle shape, a trapezoid shape, or the like, with rounded corners. The bumper side protrusion sections V42 do not have to be provided in a state where the protruding direction is strictly toward the center position CP, as long as the protruding direction is toward the inner side of the mounting hole V4. In addition, instead of, or in addition to, the bumper side protrusion section V42 on the upper-right side in FIG. 2, a bumper side protrusion section V42 may be provided in a diagonally opposed position with the center position CP therebetween. Alternatively, for example, the bumper side protrusion section V42 on the upper-right side in FIG. 2 may be omitted. That is, the bumper side protrusion section V42 may only be provided in a position that diagonally opposes the bumper side flat section V43, with the center position CP therebetween. In other words, the structure for preventing erroneous attachment of the ultrasonic sensor 1 may be formed by a single bumper side protrusion section V42 and a single bumper side flat section V43 that are in diagonally opposed positions to each other. Alternatively, the bumper side flat section V43 may be omitted. That is, the structure for preventing erroneous attachment of the ultrasonic sensor 1 may be formed by the shape or arrangement of at least one bumper side protrusion section V42.

The configuration of each section of the ultrasonic sensor 1 is not limited to the specific example described in the embodiment above. Specifically, for example, the materials constituting each section can be modified as appropriate from the specific example described above. Furthermore, a plurality of components that are each formed of the same material may each be formed of different materials. Similarly, a plurality of components that are each formed of different materials may each be formed of the same material. In addition, a plurality of components that are seamlessly and integrally formed with each other may be formed by bonding together individual members. Similarly, a plurality of components that are formed by bonding together individual members may each be seamlessly and integrally formed.

The specific configuration of the sensor case 3 is also not limited to the specific example described above. That is, for example, the structure and extending direction of the connector section 32 may be modified as appropriate. Furthermore, the shape of the microphone support section 33 is not limited to a substantially cylindrical shape, and may be a substantially elliptical cylindrical shape, a substantially elongated cylindrical shape, a substantially polygonal cylindrical shape, or the like. Similarly, the outer shape of the ultrasonic microphone 4, that is, the microphone case 42, is not limited to a substantially circular column shape, and may be a substantially elliptical column shape, a substantially regular polygonal column shape, or the like. The electromechanical conversion element constituting the ultrasonic element 41 is not limited to a piezoelectric element. The specific configuration of the cushion member 5 is not limited to the specific example described above. That is, for example, the shape of the cushion member 5 is not limited to a substantially cylindrical shape, but may be a substantially elliptical cylindrical shape, a substantially elongated cylindrical shape, a substantially polygonal cylindrical shape, or the like.

The specific configuration of the bezel 6 and retainer 8, which are components for attaching the ultrasonic sensor 1 to a plate-shaped vehicle body component (such as the bumper V3), is not limited to the specific example described above. Specifically, for example, the detailed configuration of the bezel 6 and/or retainer 8 may be modified as appropriate from the specific example described above. Furthermore, the present disclosure is not limited to a configuration in which the bezel 6 and the retainer 8 are used to attach the sensor main body 2 to a vehicle body component. That is, for example, the bezel 6 may be integrated such that detachment from the sensor main body 2 is not possible. In other words, the present disclosure may also be preferably applied to a so-called bezel-less configuration. Alternatively, the present disclosure may also be preferably applied to a so-called retainer-less configuration. In other words, the ultrasonic sensor 1 may achieve the vehicle-mounted state without using the retainer 8, by being locked to the bumper V3 by the vibration-proof rubber 7.

There are also no specific limitations on the number of insertion sections 73 that are installed in the vibration-proof rubber 7. That is, for example, three insertion sections 73 may each be arranged at equal intervals in the circumferential direction so as be located in positions corresponding to the vertices of an equilateral triangle. Alternatively, for example, five or more insertion sections 73 may be arranged at equal intervals in the circumferential direction. That is, in order to provide the centering function of the bezel 6 with respect to the mounting hole V4, the insertion sections 73 are provided in at least three locations so as to surround the center axis line CL.

It is assumed that the components constituting the embodiment are not necessarily essential, except in cases where it is specifically stated that the components are essential, and in cases where the components can be clearly considered to be fundamentally essential. Moreover, the number of constituent elements in the present disclosure is not limited to a specific number, except in cases where numerical values such as the number, numerical value, amount or range of the constituent elements are mentioned, such as in specific cases where it is specifically stated that a specific number is necessary, and in cases where there is a clear, fundamental constraint that requires a specific number. Similarly, the shapes, directions, and positional relationships of the constituent elements and the like in the present disclosure are not limited, except in cases where the shapes, directions, and positional relationships are mentioned, such as in specific cases where it is specifically stated that the shapes, directions, and positional relationships are necessary, and in cases where the there is a fundamental constraint that requires specific shapes, directions, and positional relationships.

The modifications are also not limited to those illustrated above. That is, for example, various modifications can be adopted in addition to those illustrated above. Furthermore, a plurality of modifications can be combined with each other as long as unless technically inconsistent.

### Disclosure Content

As is clear from the description of the embodiment and modifications above, at least the following disclosure items have been disclosed herein.

### Aspect 1

An ultrasonic sensor (1) configured to be attached to a plate-shaped vehicle body component (V3), comprising:
a tubular housing component (6) that is inserted into a through-hole (V4) formed in the vehicle body component; and
a vibration-proof rubber (7) that, as a result of being attached to the housing component, is interposed between the housing component and the vehicle body component in an attached state, in which the housing component is attached to the vehicle body component; wherein
the vibration-proof rubber has three or more insertion sections (73) that, in the attached state, as a result of being inserted through the through-hole, are held between an inner edge (V41) of the through-hole and the housing component in a radial direction that intersects a center axis line (CL) of the housing component, and
the three or more insertion sections are arranged so as to surround the center axis line.

### Aspect 2

The ultrasonic sensor according to aspect 1, wherein
each of the insertion sections is formed such that a dimension in an axial direction, which is parallel to the center axis line, is larger than a thickness of the vehicle body component.

### Aspect 3

The ultrasonic sensor according to aspect 1 or 2, wherein
the housing component includes a tubular section (61), and a slippage-preventing flange section (62) that protrudes at one end section of the tubular section in an axial direction, which is parallel to the center axis line, in a centrifugal direction away from the center axis line,
the vibration-proof rubber further includes an elastic spacer section (72) that is formed into a ring shape so as to be held between the flange section and the vehicle body component in the attached state, and
the insertion sections are provided protruding from the elastic spacer section in the axial direction.

### Aspect 4

The ultrasonic sensor according to any one of aspects 1 to 3, wherein
the through-hole has a vehicle body side protrusion section (V42) that is provided protruding toward an inner side,
the housing component has a sensor side concave section (68) recessed in conformity with a protruding shape of the vehicle body side protrusion section, and is configured such that the sensor side concave section engages the vehicle body side protrusion section in the attached state, and
the insertion sections are provided, in the attached state, in different positions to that of the vehicle body side protrusion section in a circumferential direction, which surrounds the center axis line.

### Aspect 5

The ultrasonic sensor according to aspect 4, wherein
the insertion sections are provided between a pair of vehicle body side protrusion sections in the circumferential direction in the attached state.

### Aspect 6

The ultrasonic sensor according to aspect 4 or 5, wherein
the vehicle body side protrusion section is formed in a plurality of locations.

### Aspect 7

The ultrasonic sensor according to any one of aspects 1 to 6 wherein
the vehicle body component is formed of a metallic plate material.

What is claimed is:

1. An ultrasonic sensor configured to be attached to a plate-shaped vehicle body component, comprising:
a tubular housing component that is inserted into a through-hole formed in the vehicle body component; and
a vibration-proof rubber that, as a result of being attached to the housing component, is interposed between the housing component and the vehicle body component in an attached state, in which the housing component is attached to the vehicle body component; wherein
the vibration-proof rubber has three or more insertion sections that, in the attached state, as a result of being inserted through the through-hole, are held between an inner edge of the through-hole and the housing component in a radial direction that intersects a center axis line of the housing component, and
the three or more insertion sections are arranged so as to surround the center axis line.

2. The ultrasonic sensor according to claim 1, wherein
each of the insertion sections is formed such that a dimension in an axial direction, which is parallel to the center axis line, is larger than a thickness of the vehicle body component.

3. The ultrasonic sensor according to claim 1, wherein
the housing component includes a tubular section, and a slippage-preventing flange section that protrudes at one end section of the tubular section in an axial direction, which is parallel to the center axis line, in a centrifugal direction away from the center axis line,
the vibration-proof rubber further includes an elastic spacer section that is formed into a ring shape so as to be held between the flange section and the vehicle body component in the attached state, and
the insertion sections are provided protruding from the elastic spacer section in the axial direction.

4. The ultrasonic sensor according to claim 1, wherein
the through-hole has a vehicle body side protrusion section that is provided protruding toward an inner side,
the housing component has a sensor side concave section recessed in conformity with a protruding shape of the vehicle body side protrusion section, and is configured such that the sensor side concave section engages the vehicle body side protrusion section in the attached state, and
the insertion sections are provided, in the attached state, in different positions to that of the vehicle body side protrusion section in a circumferential direction, which surrounds the center axis line.

5. The ultrasonic sensor according to claim 4, wherein
the insertion sections are provided between a pair of vehicle body side protrusion sections in the circumferential direction in the attached state.

6. The ultrasonic sensor according to claim 4, wherein
the vehicle body side protrusion section is formed in a plurality of locations.

7. The ultrasonic sensor according to claim 1, wherein
the vehicle body component is formed of a metallic plate material.
